(19) United States
(12) Patent Application Publication
(10) Pub. No.: US 2013/0144720 A1
(43) Pub. Date: Jun. 6, 2013

(54) System for Advertisement Display

(71) Applicants: Rahul Hari, Bangalore (IN); Ashutosh Kumar, Bangalore (IN); Neeraj Bagdia, Bangalore (IN)

(72) Inventors: Rahul Hari, Bangalore (IN); Ashutosh Kumar, Bangalore (IN); Neeraj Bagdia, Bangalore (IN)

(73) Assignee: Yahoo! Inc., Sunnyvale, CA (US)

(21) Appl. No.: 13/311,851

(22) Filed: Dec. 6, 2011

(51) Int. Cl. G06Q 30/02

(52) U.S. Cl. 705/14.55; 705/14.4

(57) ABSTRACT

A computer-implemented interactive advertisement display on a page includes a display area and a rotation control input module. The display area displays an advertisement from a set of advertisements. The rotation control input module is configured to receive a rotation control input controlling which advertisement from the set of advertisements is displayed in the display area.

### TECHNICAL FIELD

The present description relates generally to a system and method, generally referred to as a system, for displaying advertisements.

### BACKGROUND

Hundreds of millions of websites and huge volumes of online advertising are communicated around the world every day. A market exists for the distribution of advertising and other information over data communications and entertainment networks. A non-limiting example is insertion of advertising copy supplied by advertisers, for appearance on web pages, content offered by media distributors such as news and information services, internet service providers, and suppliers of products related to the advertiser's products or services.

Digital media offers marketers a rapid, highly targeted, interactive, measurable and cost effective route to target consumers—something that may become even more important in times of uncertainty. With huge volumes of webpages being created daily, bringing with them a similar surge of new inventory, online publishers may seek to maximize their yields right across their properties by monetizing their inventory and maximizing advertising opportunities.

### SUMMARY

A computer-implemented interactive advertisement display on a page includes a display area and a rotation control input module. The display area displays an advertisement from a set of advertisements. The rotation control input module is configured to receive a rotation control input controlling which advertisement from the set of advertisements is displayed in the display area.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for managing advertisement display.

FIG. 2 is a block diagram of an exemplary advertisement display.

FIG. 3 is a flow diagram of a method of managing advertisement displays.

FIG. 4 is a block diagram of a number of advertisements for use with a system for managing advertisement display.

FIG. 5 is a block diagram illustrating a method and system for managing advertisement display.

FIG. 6 is a block diagram illustrating a method and system for managing advertisement display.

FIG. 7 is a flow diagram of a method of managing advertisement displays.

FIG. 8 is a flow diagram of an alternative method of managing advertisement displays.

FIG. 9 is a block diagram of an exemplary processing system for executing advertisement impression distribution systems and methods.

### DETAILED DESCRIPTION

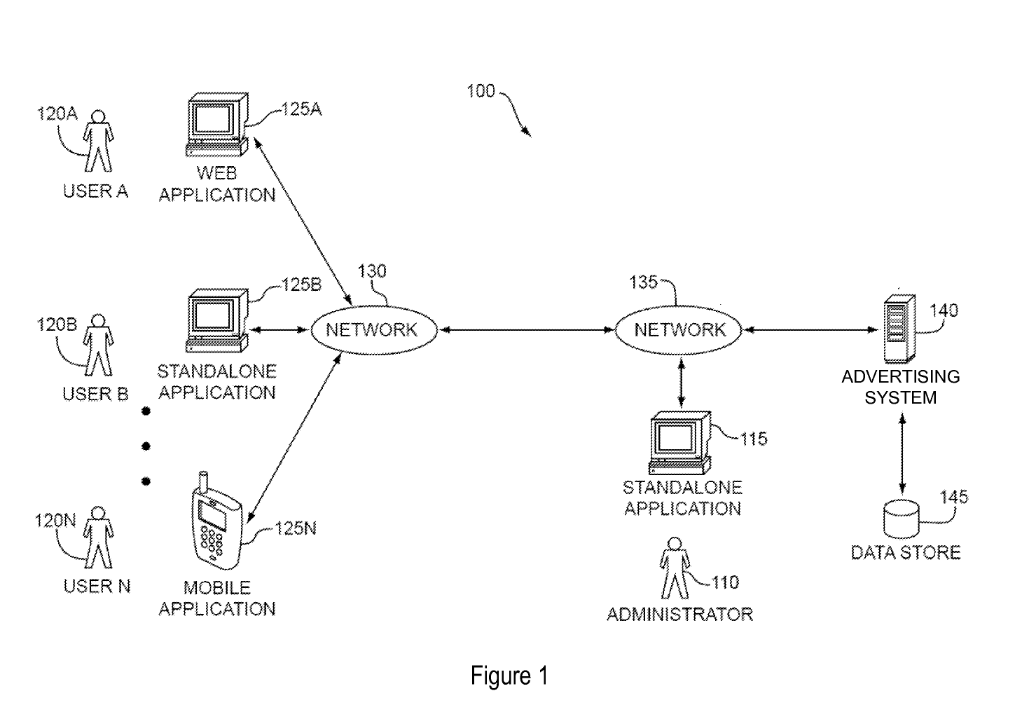

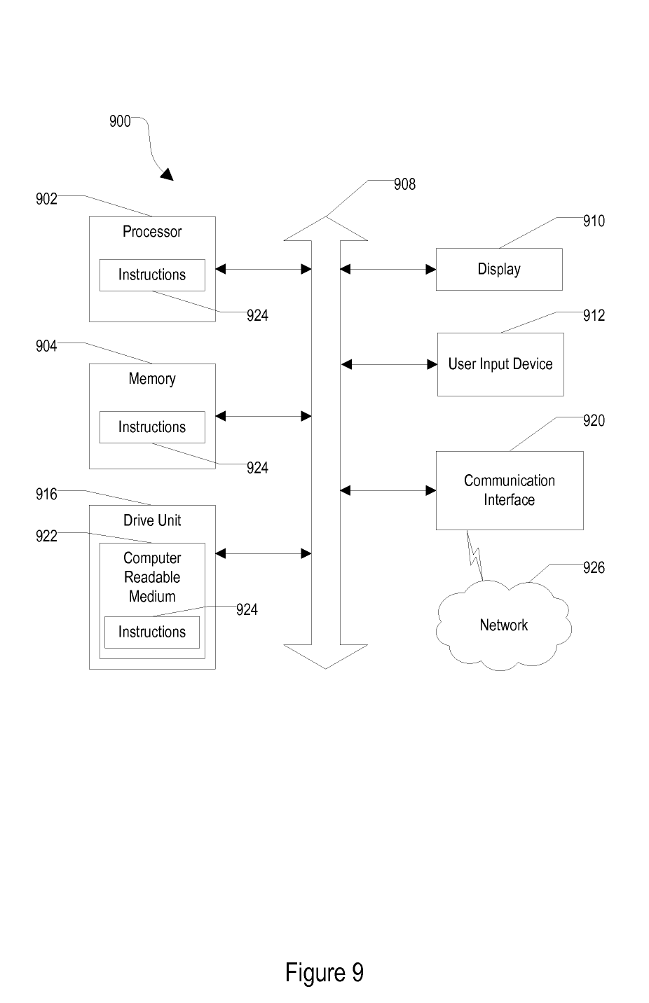

FIG. 1 provides a simplified view of a network environment 100 for serving advertisements or advertisement impressions to one or more users. The network environment 100 may include an administrator 110 and one or more users 120A-120N with access to one or more networks 130, 135, and one or more web applications, standalone applications, mobile applications 115, 125A-125N, which may collectively be referred to as user applications or client applications. The network environment 100 may also include one or more advertisement systems 140 and related data stores 145. The advertisement system 140 and client applications 115, 125A-125N may be one or more computing devices of various kinds, such as the computing device described below in conjunction with FIG. 9. Not all of the depicted components may be in every system, however, and some implementations may include additional components not shown in the figure. Variations in the arrangement and type of the components may be made without departing from the spirit or scope of the claims as set forth herein.

The administrator 110 and/or users 120A-120N may communicate with each other and/or with an advertising system 140 using a web application 125A, a standalone application 115 or 125B, or a mobile application 125N. The web applications, standalone applications and mobile applications 115 and 125A-125N may be connected to and communicate through one or more networks 130 and 135 in any configuration that supports data transfer.

A user 125A-125N may request information, content, or a page. For example, a user 120A may request content or a page, such as web pages, via a web application, standalone application, mobile application 125A-125N, such as web browsers. A user request for content or a page may be transmitted to, accessed by, and/or fulfilled by an online provider, content provider, and/or other web or electronic provider (“online provider”). The online provider may store, gather, provide, and/or otherwise transmit the requested content or page to the user.

Information, content, and/or a page requested by a user may create one or more advertisement opportunities (“ad opportunities”). Ad opportunities may include opportunities to insert online advertising, such as with content sent to a user 120A-120N. For example, variable banner ads may be inserted to fill ad opportunities that arise in web pages that are transmitted to users. Alternatively and/or in addition, an advertisement or advertiser listing may be inserted into a list of results returned in response to a user search query. Alternatively and/or in addition, for example, an advertisement or advertiser listing may be inserted when a user is playing a game on a web site, a mobile phone, or a smart phone. Alternatively and/or in addition, an advertisement or advertiser listing may be inserted when a user is using an application on a web site, on a mobile phone, or on a smart phone. In another example, content requested may be formatted so that an advertisement may be overlaid on top of or in between the content. In another example, a requested page may be formatted so that an audio, video, and/or other media advertisement may be played while the content is displayed. Ad opportunities may arise anytime a user visits a page, enters a search query, plays a game on a website or phone, uses an application on a website or phone, or uses a search engine. Various other examples are possible.

An online provider fulfilling a user's request for information, content, and/or a page may additionally or alternatively include, access, or otherwise be in communication with an advertising system 140. The advertising system 140 may be used to add, insert, or otherwise fill one or more ad opportunities for the users 120A-120N with one or more advertisement impressions or advertisements (“advertisements” or “ads”). Advertisements may include any information which an entity wishes to be disseminated to another. For example, advertisements may include information for or about an entity, product, or service. Alternatively or in addition, advertisements may include any other information, messages, data, or otherwise that an entity wishes to convey. Advertisers may be any individual, group of individuals, or entity which wishes to convey or disseminate any information, message, data, or otherwise to another. In some systems, the advertising system 140 may include or access a data store 145 which may store one or more advertisements.

The advertising system 140 may be in communication with the online provider and/or client applications 115, 125A-125N, such as over or using the networks 130, 135. In some systems, the online provider and/or advertisement system 140 may provide an interface to the users 120A-120N through the client applications 125A-125N, such as a user interface for inputting search requests and/or viewing web pages. Alternatively or in addition, the online provider and/or advertisement system 140 may provide a user interface to the administrator 110 via the client application 115, such as a user interface for managing the data source 145 and/or configuring advertisements. The advertisement system 140 may exist on one machine or may be running in a distributed configuration on one or more machines. Other examples are possible.

In some systems, the advertising system 140 may gather, provide, and/or display one advertisement in each ad opportunity, irrespective of the amount of time the advertisement is displayed or the time a user spends reviewing the requested content or page. In some systems, however, a user may remain on a page for an extended period of time. For example, a user may request and/or receive a page or content related to a recipe which the user may diligently view and follow for as much as a half hour or longer. In another example, many more recent content or pages may be designed and/or formatted as vertical content sites which keep a user focused on the same page but change the refresh content. Some examples of these may include gaming sites, social networks, and applications, and/or may incorporate one or more technologies such as Ajax or Flash. Accordingly, in some of these circumstances, it may be beneficial to serve more than one advertisement in the ad opportunity.

As such, in some systems, the advertising system 140 may create, generate, and/or manage one or more interactive advertisement displays. The advertising system 140 may select and gather one or more advertisements in an advertisement set. The interactive advertisement displays may be used to display the set of advertisements, one at a time, in a display area.

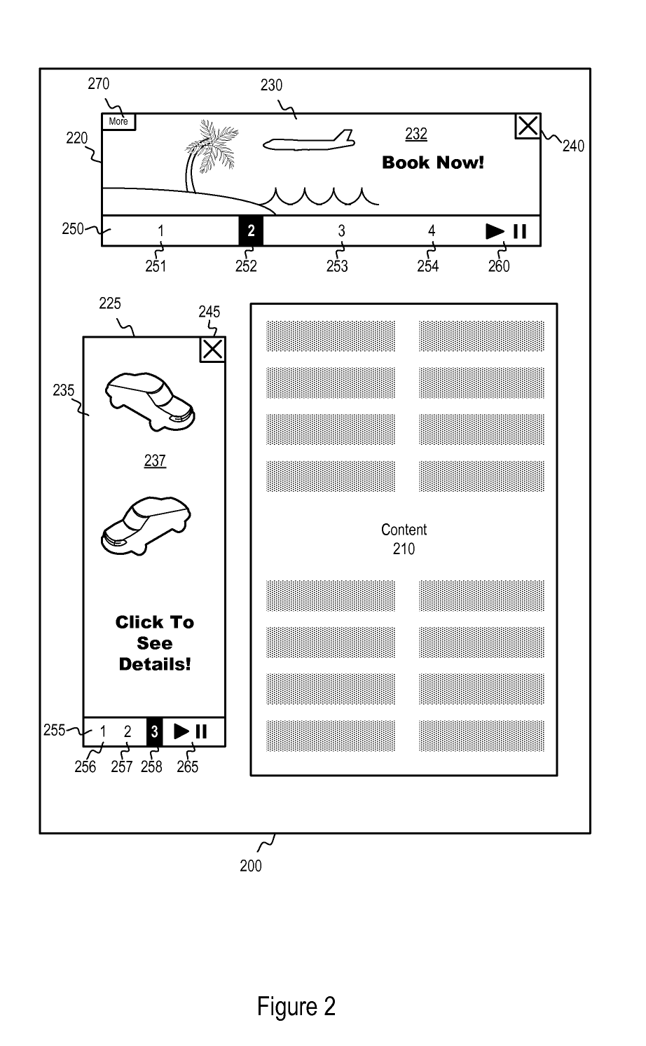

FIG. 2 illustrates an example of a page 200 displaying content 210 that a user may request, be directed to, or otherwise be interested in. The page 200 may also or alternatively include one or more interactive advertisement displays 220 and 225 that may be created, generated, and/or managed by an advertising system 140. The interactive advertisement displays 220 and 225 may be used to display one or more advertisements 232 and 237 in an ad opportunity. Each interactive advertisement display 220 and 225 may be configured to display a set of advertisements in an order and/or in a rotational fashion. An order, rotation, or interchange of advertisements may be based in part or completely on one or more of interactions with one or more display parameter, interactions with a previous or presently displayed advertisement, or interactions with other components or modules as discussed. The advertisement sets may include advertisements gathered from the performance of one or more auctions, selected based on relevance, or identified in various other ways. In some systems, additional advertisements may subsequently be gathered through a second or subsequent auction which may be conducted before, during, or after all of the advertisements from the first gathered set have been viewed. Other variations are possible.

The interactive advertisement displays 220 and 225 may be or include an advertising widget that may be useful to allow a user to browse through a set of advertisements that may have been selected for the user and interact more deeply with the advertisement. For example, the interactive advertisement display 220 may allow a user to select an ad in the advertising set, reply or interact with an advertisement, stop or start a refresh of the advertisements, ask for a refresh of the advertisement set itself, and/or perform various other functions.

Interactive advertisement display 220 and 225 may include display areas 230 and 235. The display areas 230 and 235 may be or represent where one or more advertisements 232 and 237, such as one or more winning advertisements from an auction, may be displayed. The display areas 230 and 235 may be various sizes or shapes. In some systems, the size or shape of the display area 230 or 235 may be a parameter when conducting the auction for the ad opportunity, such that bids associated with advertisements that did not fit within the size or shape may not be considered. In other systems, the size or shape of the display area 230 or 235 may change to fit the size or shape of advertisements associated with the highest bids in an auction for the ad opportunity. Each display area 230 and 235 may display one or multiple advertisements at one time. Other examples are possible.

Each interactive advertisement display 220 and 225 may include at least one display area. In some systems, an interactive advertisement display 220 may include two or more display areas. For example, half of an interactive advertisement display may include a first display area and the other half of the interactive advertisement display may include a second display area. In systems where the interactive advertisement display has more than one display area, multiple advertisements may be displayed simultaneously. In systems with more than one display area for each interactive advertisement display, each display area may rotate and/or display a different set of advertisements. For example, a first set of advertisements may be gathered, such as through a first auction, to be displayed within a first display area of an interactive advertisement display, while a second set of advertisement may be gathered, such as through a second auction, to be displayed within a second display are of the same interactive advertisement display. Alternatively, multiple display areas in an interactive advertisement display may rotate and/or display advertisements from the same set of advertisements. Any number of display areas may share or have a different set of advertisements to rotate through and display. Other variations are possible.

The interactive advertisement display 220 may display an advertisement 232 or set of advertisements in a display area in accordance with one or more rotation parameters and/or display parameters (“display parameters”). Display parameters may include which advertisement will be displayed, an order for displaying advertisements, how long an advertisement will be displayed before a second advertisement is substituted, which direction to move through an ordered set of advertisements that will be displayed, whether or not to pause a displayed advertisement, circumstances when a display area replaces the displayed advertisement with another advertisement (such as when a user scrolls up or down the page or interacts with a tab or icon on the page), a size, shape, or other display feature of the display area 230, and various other parameters or functions.

In some systems, the interactive advertisement display 220 may have a default set of display parameters. For example, the advertising system 140 may arrange for the advertisements to be displayed for 30 seconds each, in an order of the bid associated with the advertisements, such that the advertisement associated with the highest bid is displayed first. Other examples of default parameters are possible.

The interactive advertisement display 220 may have one or more modules or inputs which may be used to modify, control, alter, change, or otherwise manage the display area 230 and/or one or more of the display parameters.

For example, the interactive advertisement displays 220 and 225 may include one or more close advertisement modules 240 and 245. The close advertisement modules 240 and 245 may be an interactive button, link, modules, input points, or hot spot. The close advertisement modules 240 and 245 may be activated or interacted with in various ways, such as by clicking or selecting the close advertisement modules 240 and 245 with a mouse or other input device. When activated or interacted with, the close advertisement modules 240 and 245 may modify or control the display area 230 and/or a display parameter. For example, interaction with a close advertisement module 240 may minimize, remove, or otherwise eliminate a portion or all of the advertisements 232 and 237 and/or the interactive advertisement displays 220 and 225 respectively. In some systems, no close advertisement modules 240 or 245 may be included in the interactive advertisement displays 220 and 225. In other systems, the close advertisement modules 240 and 245 may be deactivated or not clickable at some points, such as prior to the display of some or all winning advertisements. In some of these systems, the close advertisement modules 240 and 245 may become active or clickable at various other points or times, such as once all winning advertisements have been displayed at least once. Other variations are possible.

As another example of a module or control that may modify, control, alter, change, or otherwise manage the display area 230 and/or one or more of the display parameters, the interactive advertisement displays 220 and 225 may include advertisement display control panels 250 and 255. The advertisement display control panels 250 and 255 may include one or more advertisement identifiers 251, 252, 253, 254, 256, 257, and 258. The number of advertisement identifiers 251, 252, 253, 254, 256, 257, and 258 for each advertisement display control panel 250 and 255 may or may not indicate how many advertisements are or will be displayed in each display area 230 and 235 respectively. The number of advertisement identifiers 251, 252, 253, 254, 256, 257, and 258 may or may not indicate which advertisement in a larger sequence of advertisements is presently displayed. For example, one or more of the advertisement identifiers 252 and 258 may be highlighted or otherwise indicate which advertisement is presently displayed in the display areas 230 and 235 respectively. In some systems, an interaction with an advertisement identifier may be received as an advertisement selection input, and may modify, change, control, and/or manage the display area 230 and/or a display parameter by changing the displayed advertisement to the advertisement corresponding to the selected advertisement identifier in the display area 230. Other examples are possible.

As another example of a module or control that may modify, control, alter, change, or otherwise manage the display area 230 and/or one or more of the display parameters, the advertisement display control panels 250 and 255 may additionally or alternatively include one or more rotation control input module 260 and 265. The rotation control input modules 260 and 265 may include one or more buttons, links, modules, input points, or hot spots. The rotation control input modules 260 and 265 may receive rotation control inputs, which may control the display area 230 and/or one or more display parameters. The rotation control input modules 260 and 265 may be activated or interacted in various ways, such as by clicking or selecting with a mouse or other input device, and/or may affect and/or control one or more rotation or display parameters. In some systems, rotation control input module 260 may include a play/pause button. If the play/pause button is not selected, the interactive advertisement display 220 may sequentially display winning advertisements in the display area 230, each for a given time. Once the play/pause button is selected, the interactive advertisement display 220 may freeze any rotation of the advertisements and keep only one advertisement displayed in the display area 230 until the play/pause button is again selected. In some systems, fast forward, rewind, shuffle, mute, randomize, or other buttons or controls may also or alternatively be included.

An interactive advertisement display 220 may react to the receipt of a rotation control input in various ways, and/or the interaction may depend on which of one or more rotation control input modules 260 are selected and/or what type of rotation control input is received. One or more rotation control inputs may control a display and/or rotation of advertisements within the interactive advertisement display. For example, the rotation control input received at or with one of the rotation control input modules 260 and 265 may control one or more rotation parameters and/or display parameters of the display area 230.

In some systems, an interactive advertisement display 220 may not have an advertisement display control panel 250, advertisement identifiers 251, 252, 253, or 254, and/or rotation control input module 260. In some systems, the advertisement identifiers and/or the rotation control input modules may not be located together or on an advertisement display control panel 250. Where multiple interactive advertisement displays 220 and 225 are both shown with one page 200, the interactive advertisement displays 220 and 225 may be similar or the same, or may be different.

One or more interactive advertisement displays 220 may include an additional advertisement request module 270. The additional advertisement request module 270 may include one or more buttons, links, modules, input points, or hot spots. The additional advertisement request module 270 may be activated or interacted with in various ways, such as by clicking or selecting with a mouse or other input device.

Users may select the additional advertisement request module 270 when the user wishes to see more advertisements than those presently being shown. The additional advertisement request module 270 may request a new or refreshed set of advertisements from the advertising system 140. Upon selection of the additional advertisement request module 270, an advertising system 140 may refresh the set of advertisements and/or gather a new set of advertisements to be displayed in the interactive advertisement display 270. In some systems, selection of the additional advertisement request module 270 may trigger the advertising system 140 to run another auction for new advertisements to be selected and subsequently displayed to the user in the display area 230. A user may select the additional advertisement request module 270 as often as desired. Each time the additional advertisement request module 270 is selected, new set of advertisements may be gathered to be displayed to the user.

In some systems, selection of the additional advertisement request module 270 may configured and/or indicate that a user is interested in more advertisements like one of the advertisements being shown to the user. For example, the additional advertisement request module 270 may be labeled “more advertisements like this.” A selection of the additional advertisement request module 270 labeled in that manner may provide the advertising system 140 with data and information about the type of advertisements that the user wishes to see. In these situations, new advertisements may be gathered and/or subsequent auctions held upon the selection of the additional advertisement request module 270. In some systems, the newly selected advertisements may be limited to those for advertisements that are similar to the advertisement that was displayed when the additional advertisement request module 270 was selected. In other interactive advertisement displays 225, no additional advertisement request module 270 may be included. Other variations are possible.

In some systems, an interaction with an advertisement displayed, or a portion of an advertisement displayed, may trigger one or more additional advertisement functions. For example, in some systems, an interaction with an advertisement, or a portion of an advertisement such as a selectable button or hotspot, may allow a user to search for an additional advertisement related to the displayed advertisement, from the same advertiser as the advertiser associated with the displayed advertisement, and/or for a product similar to the product displayed or advertised in the displayed advertisement. As another alternatively, in some systems, an interaction with an advertisement, or a portion of an advertisement such as a selectable button or hotspot, may automatically gather, include within the advertisement set, and/or display an additional advertisement related to the displayed advertisement, from the same advertiser as the advertiser associated with the displayed advertisement, and/or for a product similar to the product displayed or advertised in the displayed advertisement. Other variations are possible.

In some systems, one or more of the close advertisement modules 240 and 245, advertisement display control panels 250 and 255, rotation control input modules 260 and 265, advertisement identifiers 251, 252, 253, 254, 256, 257, 258, and/or advertisement request module 270 may be monitored by one or more hardware components, software components, firmware components, and/or combinations of components. For example, the advertising system 140 may monitor one or more of the close advertisement modules 240 and 245, advertisement display control panels 250 and 255, rotation control input modules 260 and 265, advertisement identifiers 251, 252, 253, 254, 256, 257, 258, and/or advertisement request module 270. When an input or interaction is detected by the advertising system 140 through or with one of these modules, panels, inputs, or buttons, the advertising system 140 may respond by controlling or managing the display area 230 or other functions as described. Other variations are possible.

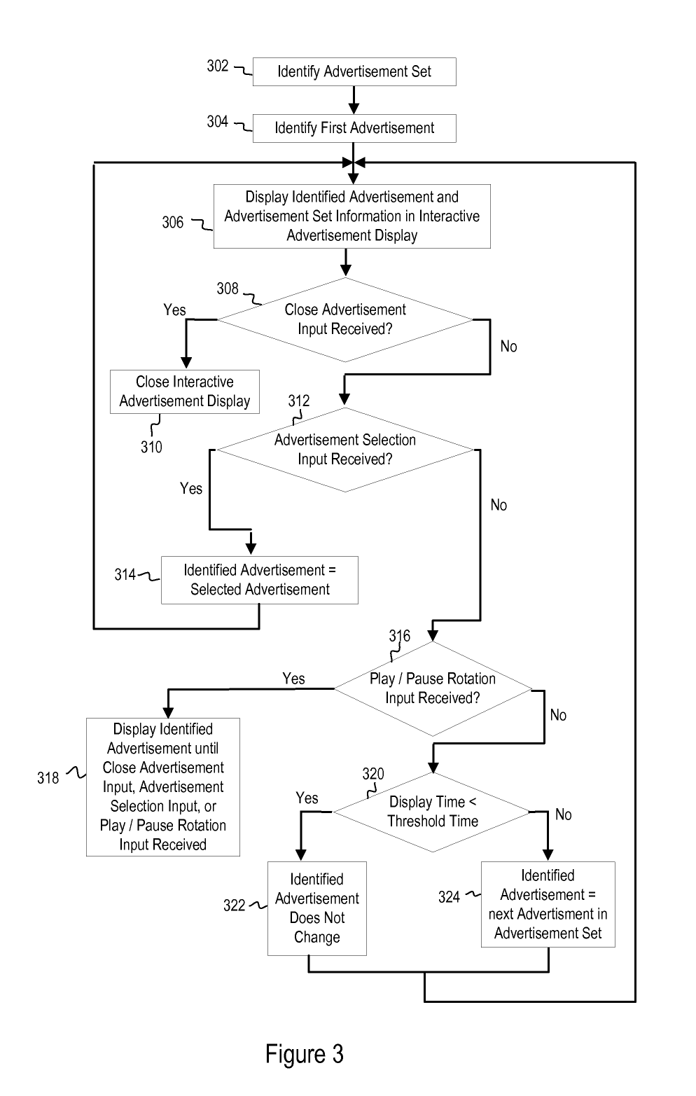

FIG. 3 illustrates an example method for displaying a set of advertisements in an interactive advertisement display such as interactive advertisement display 220.

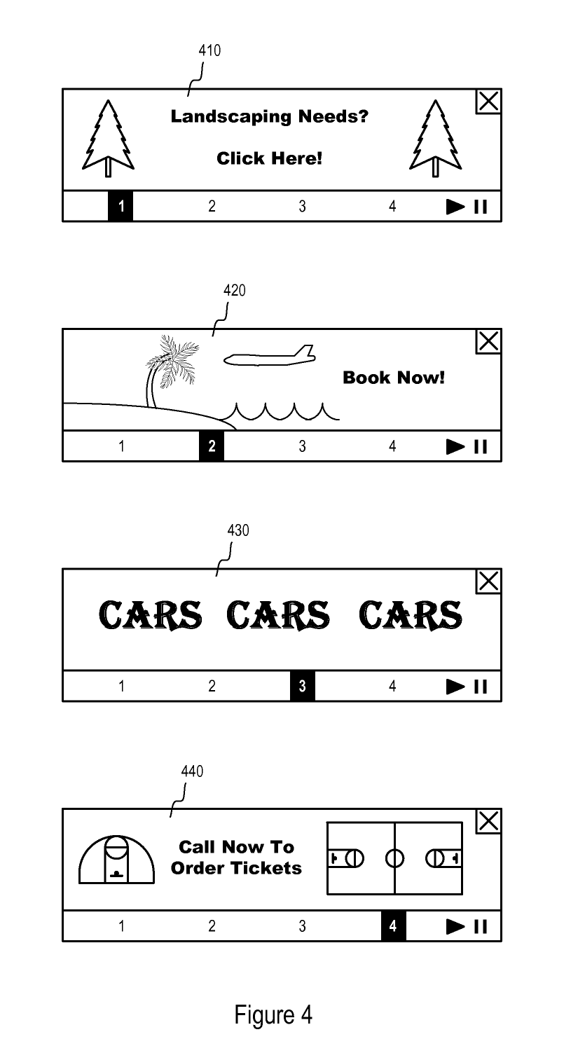

The method may begin at block 302 where an advertisement set is identified. FIG. 4 illustrates an example advertisement set that includes four advertisements 410, 420, 430, and 440 that may be used with one or more interactive advertisement display 220 or 225. In some systems, the advertisement set may be a set of winning advertisements gathered in one or more auctions for advertisement display rights with an ad opportunity. In other systems, the set of advertisements may be determined in various other ways. For example, in some systems, advertisements may be placed in or part of advertisement sets based on one or more characteristics of the user or user's profile, and/or one or more characteristics of the advertisements, such as content, bid amounts, advertisers, nature of the advertisement, or various other parameters. In other systems, the advertisement set may be a set of advertisements for one advertiser. In some systems, the advertisement set may be a comprehensive set of all advertisements to be displayed in an interactive advertisement display 220. Various other advertisement sets or ways of identifying advertisements are possible.

At block 304, a first advertisement from the advertisement set may be identified. In some systems, such as in some systems where the advertisement set comprises winning advertisements from an auction, the first advertisement may be the advertisement associated with the highest bid, or with the winning bid for the first or priority advertisement placement, from the one or more auctions. In other systems, the first advertisement may be a first advertisement in a series of advertisements, such as a series of advertisements intended to be displayed in a chronological order. In other systems, the first advertisement may be the advertisement identified as most relevant to the user or the content requested by the user. In other systems, the first advertisement may be selected based on a combination of any of the above factors or various other factors, or may be randomly selected. Various other ways of identifying the first advertisement are possible.

At block 306, the identified first advertisement is displayed in the display area 230 of the interactive advertisement display 220. In addition, in some systems, advertisement set information may be displayed with the interactive advertisement display 220. The advertisement set information may include or identify one or more characteristics and/or parameters about or regarding the advertisement set and/or the displayed advertisement, such as how many advertisements are in the advertisement set and/or which advertisement is displayed. For example, a number of advertisement identifiers 251, 252, 253, and 254 may be displayed in the interactive advertisement display, indicating how many advertisements are in the advertisement set, with the highlighted advertisement identifier 252 identifying which advertisement from the advertisement set is presently being displayed. In other systems, different or no advertisement set information may be displayed.

At block 308, the method may determine whether or not a close advertisement input has been received. For example, a user activation, selection, or other interaction with one or more close advertisement modules 240 may be detected and/or interpreted as a close advertisement input.

If a close advertisement input has been received, the method may proceed to block 310, where the interactive advertisement display 220 may be closed. Other actions may additionally or alternatively occur at block 310. For example, in some methods, the display area 230 and/or advertisement 232 of the advertisement display 220 may be minimized, reduced, or eliminated. In some of these methods, the advertisement set information may or may not remain displayed. In other systems, the interactive advertisement display 220 may rotate to display the next advertisement in the advertisement set. Other variations are possible.

If no close advertisement input has been received, the method may proceed to block 312. At block 312, the method may determine whether or not an advertisement selection input has been received. If an advertisement selection input has been received, the method may move to block 314 where the selected advertisement may be considered the identified advertisement.

In some systems, a user activation, selection, or other interaction with one or more advertisement identifiers 251, 252, 253, and 254 may be detected and/or interpreted as an advertisement selection input. For example, a user may click on the advertisement identifier 253 in the interactive advertisement display 220. This click may be detected as an advertisement selection input requesting the advertisement 430 associated with the number “3.” Accordingly, at block 314, the advertisement 430 may be considered the identified advertisement.

As another example of an advertisement selection inputs, a user may select or otherwise interact with a “forward” or “back” rotation control input module 260 on the advertisement display control panel 250. Where a “forward” rotation control input module 260 is selected, the next advertisement in the set of advertisements may be considered the identified advertisement. Where a “back” rotation control input is received, the previous advertisement in the set of advertisements may be considered the identified advertisement. Various other examples of advertisement selection inputs are possible.

Where a selection advertisement input has been received and the selected advertisement is the identified advertisement, the method may proceed back to block 306. The new selected advertisement, considered the identified advertisement, may be displayed at block 306. Additionally or alternatively, updated advertisement set information may be displayed. For example, the advertisement identifier of the selected advertisement may be highlighted or otherwise identified, while the other advertisement identifiers may not be highlighted or otherwise identified. The method may then proceed as discussed.

If no advertisement selection input is received, the method may proceed to block 316. At block 316, the method may determine whether or not play/pause rotation input has been received. Play/pause rotation input may be detected where a user interacts, clicks, selects, or otherwise activates a play/pause rotation input 260. Once the play/pause button is selected, the interactive advertisement display 220 may freeze any rotation of the advertisements and keep only one advertisement displayed in the display area 230 until the play/pause button is again selected.

Where the method detects a play/pause rotation input, the method may proceed to block 318. At block 318, the method may display the identified advertisement until any one of a close advertisement input, advertisement selection input, or play/pause rotation inputs are received. Where a close advertisement input is received, the method may proceed to block 310. Where an advertisement selection input is received, the method may either proceed to block 314, or may switch the advertisement displayed in the display area 230 to the selected advertisement and thereafter return to block 318. Where a play/pause rotation input is received, the method may proceed to block 320. Other variations are possible.

If no play/pause rotation input is received, the method may proceed to block 320. At block 320, the display time of the identified and displayed advertisement may be compared to a threshold time. The threshold time may, for example, correspond to a rotation or display parameter governing how long an advertisement may be displayed during the ad opportunity. The threshold time may represent an ad life or period of time that the ad is active, after which the advertisement may be considered viewed or dead. As an example, the advertising system 140 may determine that each advertisement will be displayed for 30 seconds. In this example, the threshold time may be 30 seconds. There may be one threshold time for all advertisements, or different threshold times for one or more of the advertisements. For example, a first advertisement may have a longer or prime threshold time, with each subsequent advertisement having a shorter threshold time. In other systems, all advertisements may have the same threshold time. Where different advertisements have different thresholds times, the display time for the display of each advertisement may be compared at block 320 to the threshold time specific to that advertisements. Other variations are possible.

Where the display time for the identified advertisement is less than the threshold time, the method may proceed to block 322. At block 322, the identified advertisement does not change. From block 322, the method may proceed back to block 306, where the same identified advertisement remains displayed. From there, the method may proceed through blocks 306-320 in the manner as described before. If no inputs are received, the method may continue to cycle through these blocks of the method until the display time is equal or greater than the threshold time. In this way, the same identified advertisement may be displayed in the display area 230 of the interactive advertisement display 220 for a certain and/or designated period of time, after which another advertisement may be shown. The method may cycle through blocks 306-320 at a given frequency or interval, at various times, when triggered, in accordance with a clock cycle of a processor or advertising system 140, or at various other times.

When the display time equals or is greater than the threshold time, the method may proceed to block 324. At block 324, another advertisement in the advertisement set may be determined or deemed to be the identified advertisement. The newly determined identified advertisement may be selected or identified in various ways. For example, in some systems, the new identified advertisement may be the advertisement associated with the second highest bid in an auction for an advertisement placement, or may be the advertisement associated with the highest bid for the second or secondary advertisement placement. In another example, the new identified advertisement may be the second advertisement in an ordered set or series of advertisements. In another example, the new identified advertisement may be the second most relevant advertisement to a user or content requested by a user. In some systems, a new auction may also or alternatively be triggered. Various other examples are possible.

After block 324, the method may proceed to block 306, where the new advertisement may be displayed. Additionally or alternatively, updated advertisement set information may be displayed. The method may then proceed as discussed.

In some circumstances, at any point throughout the method of FIG. 3, the method may receive an additional advertisement request. For example, a user may select, activate, click, or otherwise interact with an additional advertisement request module 270. Upon selection of the additional advertisement request module 270, the method may return to block 302, where a new set of advertisements may be identified. For example, a new auction may be run for one or more advertisements. From block 302, the method may again proceed as discussed.

In some circumstances, at any point throughout the method of FIG. 3, a user may select, click, activate, or otherwise interact with one of the displayed advertisements 232. In systems where the displayed advertisement 232 is an interactive advertisement, various functions may occur upon interaction. For example, additional information or advertisements related to the interacted advertisement may be displayed, or the user may be redirected from the page 200 to a web page related to the advertisement. In some other systems where the displayed advertisement 232 is not an interactive advertisement, data about the interaction with the advertisement 232 may be recorded and used in subsequent auctions as additional information about the user. Other variations are possible.

The method of FIG. 3 may proceed indefinitely as long as the ad opportunity exists. The same set of advertisements may be repeatedly rotated through and displayed in the display area 230 of the interactive advertising display 220. In other systems, new advertisement sets may be gathered and displayed after all of the advertisements from the previous advertisement set have been shown. Other examples are possible.

In some circumstances, at any point throughout the method of FIG. 3, the advertising opportunity may end or disappear. For example, a user may close a page or may travel to a new page. When the ad opportunity disappears, the method of FIG. 3 may end or otherwise terminate. Various other examples are possible.

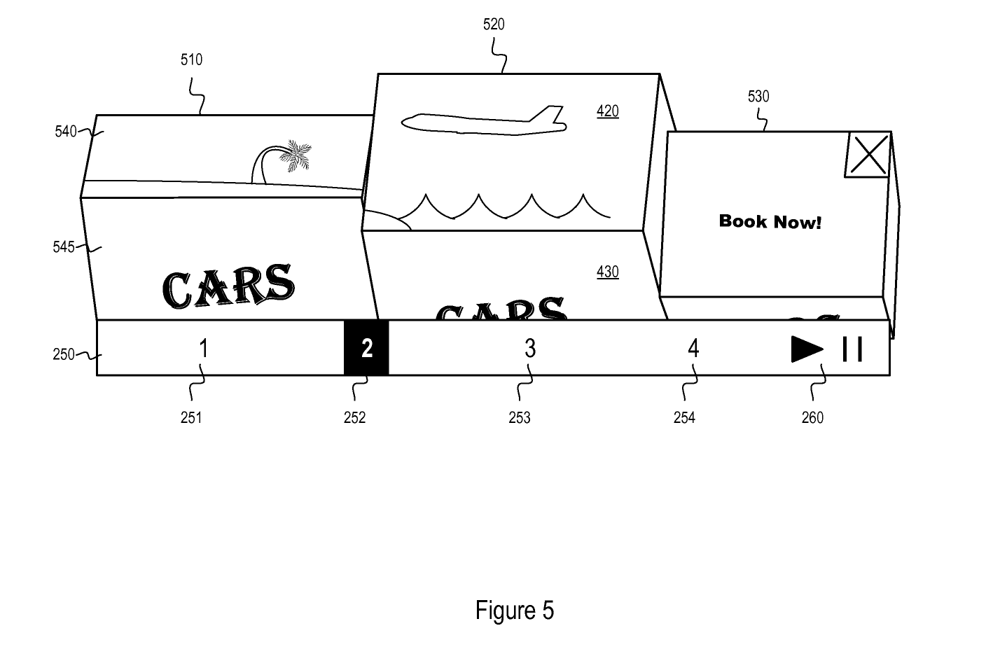

FIG. 5 shows one example of how the interactive advertisement display 220 may be manipulated, changed, or otherwise operated when one advertisement from an advertisement set is rotated or transitioned in for another advertisement, such as at blocks 324 and 306 of the method of FIG. 3. The interactive advertisement display 220 and the visual effects of the transition between advertisements may be performed by one or more software or hardware components of the advertising system 140. In FIG. 5, an advertisement 420 that had previously been displayed is being switched for a new advertisement 430 in the advertisement set.

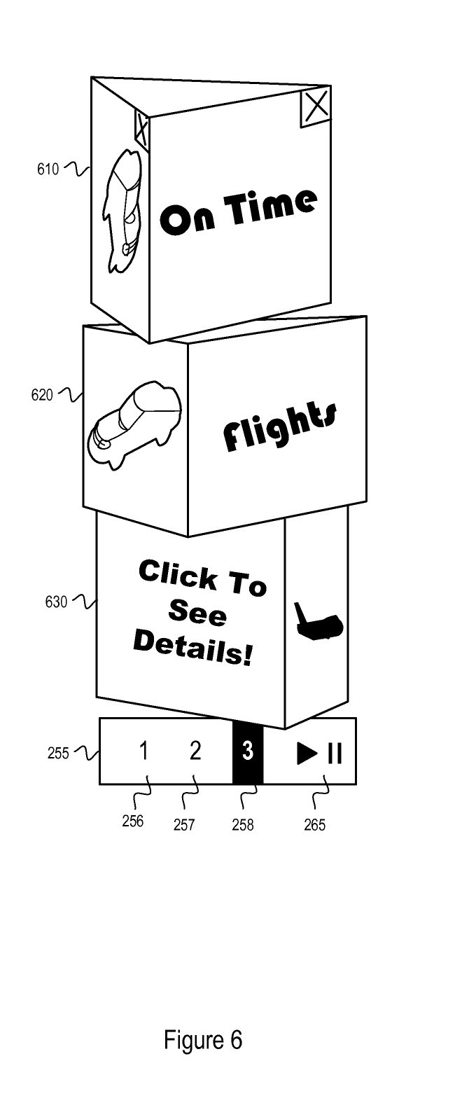

The display area 230 of the interactive advertisement display 220 may be virtually and/or visually divided or subdivided into one or more partitions, blocks, or segments, such as segments 510, 520, and 530. While three segments 510, 520, and 530 are shown in FIG. 5, any number of segments may be created. In some systems, each of the segments 510, 520, and 530 may be represented visually, virtually, and/or digitally as a three-dimensional shape. For example, each of the segments 510, 520, and 530 may have two parallel side panels of the same shape, and may have one or more additional perpendicular faces or face panels, each connecting on opposite sides to a side of the side panels. For example, each of the segments 510, 520, and 530 may have square side panels with four faces connecting the two side panels. In this example, each of the segments 510, 520, and 530 may be or represent a 3-dimensional (3-D) cube or parallelpiped. In another example, such as the example described later in FIG. 6, each segment 610, 620, and 630 may have two triangular side panels, each with three faces connecting the two triangular side panels. The number of faces or face panels may correspond to the number of sides on one of the side panels. For example, where a segment has pentagonal side panels, the segment may have five face panels. Other examples are possible.

Though shown in FIG. 5 as only dividing the display area 230 of the interactive advertisement display 220, in other examples, the advertisement display control panel 250 may also be divided with or separately from the display area 230, with a portion of the advertisement display control panel 250 appearing on each face of each segment 510, 520 and 530. Other variations are possible.

The size or shape of the segments may depend on the number of advertisements in a set. For example, where an advertisement set includes four advertisements 410, 420, 430, and 440, the segments 510, 520, and 530 may be cubes. In this example, each face of the cube may display a portion of one of the four advertisements. In this way, the number of faces of each segment 510, 520, and 530 may correspond to the number of advertisements in the advertisement set. In other examples, there may be more or less advertisements in an advertisement set than there are faces on each block. Other variations are possible.

At the time of a transition, such as where the first advertisement 420 is to be rotated out and the second advertisement 430 rotated in, one or more of the segments 510, 520, and 530 may move, transition, or be rotated along an axis. The axis may extend through each of the side panels and/or central axis of the segments 510, 520, and 530. For example, the segments 510, 520, and 530 may rotate along the same central axis extending through a center point on each of the side panels. The rotations of the segments 510, 520, and 530 may be referred to as a 3-D cube transition. The rotation of the segments 510, 520, and 530 may be performed to show or display in the display area 230 a different face of the blocks.

For example, the first segment 510 may be rotated, such that a first front panel 540 may move from a head-on and flat viewing position to an invisibly perpendicular position. Meanwhile, the second front panel 545 which had been residing perpendicular to the front panel 540 on the bottom of the first segment 510 may be rotated into the head-on and flat viewing position previously occupied by the first front panel 540. In this way, the first front panel 540 may be moved out of view with the second front panel 545 being displayed in its place. Where the segment 510 is a cube, the segment 510 may be rotated, for example, 90 degrees. In other examples, such as there the segment 610 has three front panels, the segment 610 may be rotated 135 degrees during a transition or rotation from one advertisement to the next. In still other examples where a segment has n sides, the segment may be rotated (360/n) degrees during a transition or rotation from one advertisement to the next. The movement of the block 510 may be or display a virtual or visible feeling or impression that a portion of the advertisements 420 and 430 are displayed on a side of a cube. The movement of one or more of the segments 510, 520, and 530 may be or appear to be around a horizontal axis passing through the center of the display area 230. Other variations are possible.

While the segments 510, 520, and 530 are shown rotating upwards from the bottom, it should be noted that the segments 510, 520, and 530 may be rotated in the reverse direction, such that the new advertisements to be displayed appear on a front face virtually or actually located above the previously displayed advertisement. In still other systems, the two side panels of the segments 510, 520, and 530 may be the side panels on the top or bottom of the segments 510, 520, and 530, with the front faces appearing to be the faces on the sides of the segments 510, 520, and 530. In this system, the segments may appear to rotate horizontally along a vertical axis, from either the left or the right. Other variations are possible.

Each of the segments 510, 520, and 530 may be configured in the same or a similar manner. Rotation of the segments 510, 520, and 530 may be initiated or take place at the same or different times. In some systems, the rotation of the segments 510, 520, and 530 may be offset from each other, such that it is clear to the user that each of the segments 510, 520, and 530 represent separate three-dimensional objects. In other systems, one or more of the segments 510, 520, and 530 may rotate at the same or substantially the same time. The segments 510, 520, and 530 may each be rotated or transitioned at the same or different times, at the same or different speeds, and/or with the same or different transition effects. The segments 510, 520, and 530 may be the same or different sizes. While the segments 510, 520, and 530 are shown having a plurality of flat faces, in some systems, the segments 510, 520, and/or 530 may have rounded or curved faces, and/or may be cylindrical or other shapes. Other variations are possible.

FIG. 6 shows another example of how the display area 235 of the advertisement display 225 may be manipulated, changed, or otherwise operated when one advertisement from an advertisement set is rotated or transitioned in for another advertisement, such as at blocks 324 and 306 of the method of FIG. 3. The interactive advertisement display in FIG. 6 may operate in the same or a similar manner to the interactive advertisement display in FIG. 5. In FIG. 6, however, the segments 610, 620, and 630 may have only three faces. Additionally, the segments 610, 620, and 630 may rotate horizontally around a vertical axis passing through the center of the blocks 610, 620, and 630. Other variations are possible.

In some systems, the 3-D segments 510, 520, 530, 610, 620, and/or 630 may be entirely represented digitally or virtually, such as by or using the advertising system 140, software, and/or other processing tools. For example, the advertising system 140 may create and/or generate the display area 230, may divide and/or otherwise partition the display area 230, may display one or more advertisements within the display area 230 and/or within one or more segments of the display area 230, may control one or more transitions of the display area 230, such as the rotation of one or more segments 510, 520, and 530, and/or may perform other functions. The 3-D cube transitions of the advertisements may provide smooth and/or one-directional transitions. The 3-D cube transitions may mimic or otherwise resemble physical 3-D transitions which may be incorporated in billboards or other areas of advertising. The 3-D cube transitions may represent an assimilated 3-D lookalike cube that rotates softly on one axis to rebuild different phases or advertisements, and/or may resemble a physical object sliding on one axis of the web page. These 3-D cube transitions may not compromise a user's mental peace and/or may not unduly disturb or annoy a user. While 3-D cube transitions are described herein, various other transitions or ways of rotating advertisements in interactive advertisement displays 220 are possible. For example, an advertising system 140 may simply remove one advertisement and replace it with a second advertisement, and/or may add one or more other transition effects during an advertisement rotation. For example, a transition may include or be one or more of a sliding transition, a fading or cross-fading transition, a merging, a blending, and/or various other transitions.

In selecting advertisement sets for a multiple advertisement display, such as the interactive advertising displays 220 and 230, the advertising system 140 may conduct one or more auctions for advertisements to be displayed or inserted with the ad opportunity. For example, in some systems, the advertising system 140 may, upon identification of an ad opportunity, conduct one auction to gather bids for advertisements to be displayed or inserted with the ad opportunity. The advertising system 140 may identify, selected, and/or gather advertisements associated with a designated number of the highest bids, and/or with the highest estimated cost per mille (“eCPM”), in the auction. These gathered advertisements may be gathered into an advertising set and/or may be or represent winning advertisements. The winning advertisements from the advertisement set may be rotated or cycled through, so that each of the winning advertisements is displayed with the ad opportunity for a certain period of time. In some of these systems, only one winning advertisement from the advertisement set may be displayed or inserted with the ad opportunity at any one time.

For example, the advertising system 140 may identify, select, and/or gather advertisements associated with the four highest bids, or the four highest eCPMs, in one auction conducted for an ad opportunity. A first advertisement of the four winning advertisements may be inserted with the ad opportunity first, and may be displayed for a period of time. After the first advertisement has been displayed, a second of the four winning advertisements may be inserted with the ad opportunity in place of the first advertisement, and may be displayed for a period of time. Following the display of the second advertisement, the third advertisement may be inserted and displayed, and so forth. While this example illustrates identifying, selecting, and/or gathering the top four bids in an auction, any number of the top bids may be selected.

In other systems, multiple auctions may be run for one ad opportunity. In these systems, advertisements associated with the highest bid in each of the multiple auctions may be identified, selected, and/or gathered, and may form the advertisement set. The winning advertisements from the advertisement set may be rotated or cycled through, so that each of the advertisements is displayed with the ad opportunity for a certain period of time, with only one advertisement from the advertisement set may be displayed or inserted with the ad opportunity at any one time.

In still other systems, multiple auctions may be run for one ad opportunity, with some of the auctions producing only one advertisement associated with the highest bid, while other auctions produce multiple advertisements associated with a number of the highest bids. As an example, two auctions may be held for one ad opportunity. A first auction may be conducted for the top or priority advertisement placement in the ad opportunity. One advertisement associated with the highest bid in the first auction may be identified, selected, and/or gathered as part of the advertisement set. Additionally, a second auction may be conducted for all other secondary advertisement placements with the ad opportunity. A number of advertisements associated with the highest bids in the second auction may be identified, selected, and/or gathered as part of the advertisement set.

In still other systems, an advertising system 140 may conduct one or more auctions for bids for an advertiser to display multiple advertisements. For example, an advertising system 140 may conduct one bid for an ad opportunity in which the highest bidder may have the option to display multiple advertisements with the ad opportunity. For example, a movie theater or production studio may submit a bid for an ad opportunity in which four (or any designated number) of advertisements, each for a different movie or showtime, may be identified, selected, and/or gathered as the winning advertisements. As another example, an advertiser may wish to produce a series of advertisements which may be identified, selected, and/or gathered as the winning advertisements. The series of advertisements may have a designated order of display, or may be displayed in any order. The series of advertisements may be directed to the same or a similar product, theme or market, or may be directed to different products or services. Other variations are possible.

For each auction conducted when an ad opportunity arises, the advertising system 140 may solicit bids to display an advertisement associated with the bidding advertiser in or with the ad opportunity, and may select and gather one or more advertisements associated with winning bids. The bids may be solicited and the winning advertisements identified in a variety of ways.

In some systems, the advertising system 140 may provide an automated method or way for advertisers to submit bids and/or purchase a display of an advertisement with ad opportunities. As an example, the advertising system 140 may include an interface or module through with an advertiser may set up or otherwise create an advertising campaign (“ad campaign”). An ad campaign may be used to organize an advertiser's advertisements. Advertisers may create, submit, and/or store advertisements for the ad campaign with the advertisement system 140 and/or the data store 145. The advertisers may use the ad campaign to specify and/or designate to whom, when, where, and/or how they would prefer that an advertisement be displayed.

The advertiser may be able to arrange or otherwise designate to the advertising system 140 automatic bid and/or purchase requirements for the advertiser. Bid and/or purchase requirements may include information about how frequently to submit a bid, how many ad opportunities to purchase, a bid amount for each advertisement associated with an advertiser's ad campaign, a priority associated with which advertisements to bid on, and/or information or attributes about ad opportunities to submit bids for. Different bid and/or purchase requirements may be set up by an advertiser for each advertisement of the advertiser. For example, the advertiser may arrange with the advertising system 140, such as through or using one or more ad campaigns, to bid a first amount for a first advertisement in an ad campaign each time an ad opportunity arises until the first advertisement has been displayed a designated number of times, and after which to bid a second amount for a second advertisement in the ad campaign each time a subsequent ad opportunity arises.

The bid and/or purchase requirements submitted by an advertiser may include information about what type of ad opportunities to bid on, and/or what type of ad opportunities to not bid on. For example, the advertiser may use an ad campaign to submit a bid for ad opportunities which match one or more attributes desired by the advertiser. Ad opportunity attributes may identify a particular subset of the population which the advertiser may wish to display advertisements or information to, information related to the content provided, or information related to where and how an advertisement would be displayed. For example, attributes may include, for example, a content topic of the page or display, a gender of the potential viewer, an age or age category of the potential viewer, a location of the advertisement, a location of the potential viewer, a behavior tag, a device identifier (such as a user or device specific identification number or name) or device type (such as an iPad, mobile phone, laptop, etc.) on which a user is viewing content, a time of day, day of the week, and/or other timing information for the ad impression, one or more of characteristics of an ad opportunity or display, such as who may view an advertisement and what the viewer interested in or the content of the opportunity and/or type of advertisement to fill it, a position or placement of an advertisement, a timing of an advertisement, or any other type of information pertaining to a potential viewer of an advertisement, or placement, location, type, or timing of an advertisement. Attributes may also or alternatively be identified in the negative, where an advertiser may specify that it does not wish for its advertisement to be associated with ad opportunities having a certain attribute. Any number of attributes may be entered by an advertiser in association with a bid. Specified ad opportunity attributes may aid in or ensure that advertisements or other listings may be delivered in accordance with the requirements or desires of the advertiser. In some instances, an advertiser may not enter any attributes in association with a bid, such as where the advertiser is merely interested in bidding on any ad opportunities, regardless of the attributes of the ad opportunity.

In systems where advertisers arrange to automatically bid on ad opportunities as they arise, the advertising system 140 may automatically conduct auctions for the ad opportunities. The advertising system 140 may, for example, may identify attributes of the ad opportunity. Using these attributes, the advertising system 140 may determine which ad campaigns are interested in and/or have arranged to submit an automatic bid for the ad opportunity. Only bids for those ad campaigns interested in the ad opportunity may be considered in the auction. The advertising system 140 may then automatically conduct the one or more auctions and identify, select, and/or gather winning advertisements in the advertisement set for display. Other variations are possible.

In other systems, an advertising system 140 may solicit and collect bids in a non-automated or manual way. For example, the advertising system 140 may publish information about the ad opportunity, which advertisers may review. Advertisers who find the ad opportunity desirable may bid on the ad opportunity. From the collected bids, advertisements associated with the highest bids may be identified, selected, and/or gathered as the advertisement set, as discussed. Various other systems and methods of conducting auctions and selecting winning advertisements are possible.

Once the winning advertisements are gathered as the advertising set, the winning advertisements may be inserted with the ad opportunity and displayed to the user. As discussed, each of the winning advertisements may be inserted and/or displayed individually for each ad opportunity for a period of time, after which another of the winning advertisements may be inserted and displayed instead. The order of the display of the winning advertisements may be identified and/or determined in various ways. In systems where only one auction is conducted for each ad opportunity, the order of the display of the winning advertisements may correspond to the bid amount, with the advertisement associated with the highest bid being displayed first, and the rest displayed in descending order.

In systems where multiple auctions are conducted, with only the advertisements associated with the winning bids for each auction being identified, selected, and/or gathered, the winning advertisements may be displayed according to the order identified by the auctions. For example, one of the multiple auctions may be identified as an auction for the top or priority advertisement placement. The advertisement associated with the highest bidder for the first auction may be displayed first. A second auction may be for a secondary advertisement placement, and an advertisement associated with the highest bidder of the second auction may be displayed second, and so on.

In systems where a hybrid approach is conducted, such as where one auction is conducted for the first or priority advertisement placement and a second auction is conducted for all other secondary advertisement placements, the advertisement associated with the highest bidder in the first auction may be displayed first. All subsequent advertisements may be displayed in order of associated bid amount in the second auction. Other variations are possible.

Conducting auctions to display multiple advertisements in one ad opportunity may provide many benefits and advantages. For example, this approach may benefit an online provider in that more advertisements may be served, leading to higher revenue and/or return on investment from purchasing advertisers. Online providers may be able to use the same inventory space for multiple advertisements. Additionally, advertisers may benefit with more advertisements being displayed to a user, increasing a chance or likelihood of a user interaction with the advertisements. Further, the user may benefit by being served and reviewing more advertisements, increasing the likelihood that one or more of the advertisements may be relevant and of interest to the user. As another benefit, serving multiple advertisements in a smaller number of ad opportunities may allow an online provider to reduce a number of ad opportunities included with requested content or a page without losing any revenue, thereby providing a less cluttered and more appealing display of the requested content or page to a user. Other benefits are possible.

After all of the winning advertisements from an advertisement set have been displayed, in some systems, if the ad opportunity still exists, the advertising system 140 may conduct a second set of one or more auctions. The second set of auctions may be similar to the first set of one or more auctions in that the second auction may solicit bids for advertisement placement within the ad opportunity. The number of winning advertisements in the second set of one or more auctions may be the same or different from the number of winning advertisements in the first set of one or more auctions. In some systems, only bids for advertisements which have not yet been displayed may be received or selected in the second set of one or more auctions. In other systems, no such restrictions may be placed. Based on the second set of auctions, a second set of winning advertisements may be selected and displayed in the same manner as the display of the first set of winning advertisements. Once all of the winning advertisements in the second set of advertisements have been displayed, and if the ad opportunity continues to exist, a third set of one or more auctions may be conducted, and so forth.

Holding second and subsequent auctions for an existing ad opportunity may provide numerous benefits and advantages. Online providers and/or the advertising system 140 may receive compensation for displaying more advertisements to a user. Additionally, advertisers bidding in subsequent auctions may benefit from an increased knowledge about a user. For example, at the time of the second auction, new information about the user or ad opportunity may have been received or otherwise gained since the first auction was conducted. Information about the content or interactions by the user with the content viewed by the user may provide data or information about a user's interests, likes, dislikes, or other information. As another example, information about a user's interactions with the first set of winning advertisements may provide data or information about advertisements which may be of interest or effective with a user. This information may be used by advertisers or the advertising system 140 to receive, determine, select, and gather advertisements of more relevance or interest to the user while removing or reducing the value of advertisements of less relevance or interest to the user. Where advertisers have arranged for automated bids, the increase in knowledge may narrow or broaden those advertisements that may be considered by the advertising system 140.

In some systems, the benefits to advertisers in having an increased knowledge about the user may result in higher bids and revenue for the online provider and/or advertising system 140, as advertisers may be willing to spend more direct their advertisements to users with a higher likelihood of interest. As such, in some systems, the number of winning advertisements selected for the first set of one or more auctions may be kept to a manageable size. This may increase the likelihood that the ad opportunity may still exist after all of the first set of winning advertisements have been displayed, resulting in a second set of one or more auctions. However, any number of winning advertisements may be selected in the auctions.

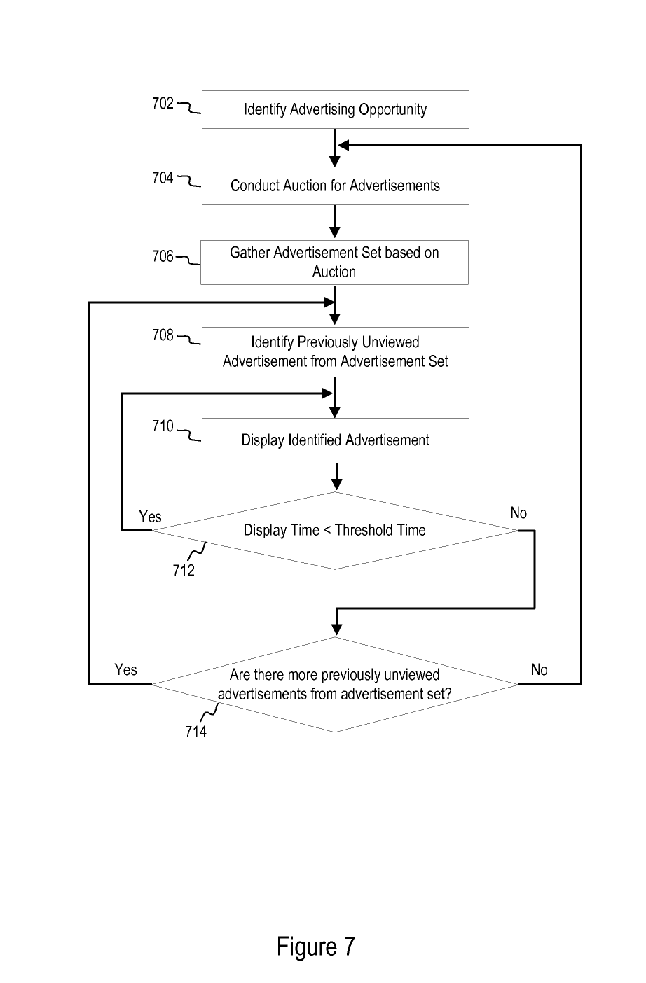

FIG. 7 illustrates a method of managing advertisements and advertisement displays. The method of FIG. 7 may be utilized and/or performed by the online provider and/or advertising system 140 alone or in combination with one or more other systems, databases, processors, or components.

The method may begin at block 702, where an ad opportunity may be identified. Ad opportunities may arise anytime a user visits a page, enters a search query, plays a game on a website or phone, uses an application on a website or phone, or uses a search engine. For example, every web site view may be an ad opportunity.

The advertising system 140 may monitor or detect a user interaction with one or more web pages associated with, or in communication with, the advertising system 140 in various ways. For example, the advertising system 140 may provide or be in communication with a system that may provide search or query web pages to users, through which a user may input one or more terms to search. In another example, the advertising system 140 may manage one or more web pages or other electronic content, and may monitor, and/or detect each time one of the web pages are accessed, at which point the advertising system 140 may be configured to insert and/or transmit an advertisement to a requesting user along with any content requested. Various other ways of monitoring or identifying an ad opportunity are possible.

At block 704, one or more auctions may be conducted. The advertising system 140 may seek one or more bids for advertisements to be placed with the identified ad opportunity (also referred to as “advertisement placement rights”). In some systems, one auction may be initiated for an advertisement placement right with an ad opportunity. In other systems, multiple auctions may be initiated for multiple advertisement placement rights with one ad opportunity.

Each of the auctions may identify, specify, or associate one or more parameters with the advertisement placement rights that are being auctioned off. Parameters may include a length of time that a winning advertisement may be displayed, an order of placement of a winning advertisement, position and location information for where the advertisement may be displayed, requirements or limitations on winning advertisements, number of winning bids accepted for each auction, or various other parameters.

At block 706, an advertisement set of one or more winning advertisements may be identified, selected, and/or gathered based on the one or more auctions. Identification, selection, and/or gathering of winning advertisements of an advertisement set may be conducted and/or performed as discussed. For example, a designated number of the highest bids for an auction may be identified, and advertisements associated with the identified highest bids may be gathered. In some systems, the selected winning advertisements are those associated with the highest bids received and considered by the advertising system 140. In other systems, the advertising system 140 may invoke one or more algorithms or rules that may consider multiple factors such as bid value, previous success of the advertisement, expected return on investment, expected or previous click-through-rates, or other factors in selecting winning advertisements. Other variations are possible.

Once the advertisement set of winning advertisements has been selected, determined, and/or gathered, the method may proceed to block 708. At block 708, a winning advertisement from the advertisement set may be identified. The identified winning advertisement may be one of the winning advertisements which has not yet been displayed or provided with the ad opportunity. The identified winning advertisement may be considered or referred to as an unviewed advertisement, since the identified winning advertisement has not been displayed to the user with the present ad opportunity.

At block 710, the identified unviewed winning advertisement may be provided and/or displayed within or to fill the ad opportunity. Once the identified winning advertisement is provided and/or displayed, the identified winning advertisement may be considered, deemed, referred to, or otherwise declared to be a viewed or dead advertisement.

At block 712, the display time of the identified and displayed advertisement may be compared to a threshold time. The threshold time may, for example, correspond to one of the advertisement placement parameters governing how long a winning advertisement may be displayed during the ad opportunity. The threshold time may represent an ad life or period of time that the ad is active, after which the advertisement may be considered viewed or dead. As an example, the advertising system 140 may determine that each winning advertisement will be displayed for 30 seconds. In this example, the threshold time may be 30 seconds. The identified winning advertisement may also or alternatively be displayed according to the one or more other advertisement placement parameters. For example, the parameters of the advertisement placement may indicate the order that advertisements will be displayed. Various other examples are possible.

Where the display time is less than the threshold time, the method may proceed back to block 710. The identified advertisement may thus continue to be displayed until the display time is no longer less than the threshold value.

When the display time is equal to or greater than the threshold time, the identified winning advertisement may have been displayed for the desired, requested, or required amount of time specified by the advertisement placement parameter. Accordingly, the method may proceed to block 714.

At block 714, a determination may be made as to whether or not the advertisement set includes any more previously unviewed advertisements. If the advertisement does include winning advertisements which have not yet been displayed within the ad opportunity, the method may proceed back to block 708. The method may then proceed again through blocks 708, 710, and 712, where another new previously unviewed advertisement is selected and displayed for a given period of time. The method may continue to move between blocks 708, 710, 712, and 714 until all of the winning advertisements have been displayed within the ad opportunity, or until the ad opportunity ends.

If all of the winning advertisements from the gathered advertisement set have been displayed and the ad opportunity still exists, in block 714, the method may move back to block 704. At block 704, a second auction or set of auctions may be conducted. The second auctions may be similar to or different than the first auction. Second or subsequent auctions held for an existing ad opportunity may benefit from an increase in knowledge about a user, which may be used to receive, determine, select, and gather advertisements of more relevance or interest to the user while removing or reducing the value of advertisements of less relevance or interest to the user.

Advertisements may be gathered for each subsequent auction in block 706 as described above. The method may proceed through blocks 704, 706, 708, 710, 712, and 714 as discussed, showing all winning advertisements from a subsequent set of one or more auctions and conducting additional auctions until the ad opportunity ends, or until no bids are submitted for a set of one or more auctions for the ad opportunity.

In some methods, at any point throughout the method of FIG. 7, the ad opportunity may end or disappear. For example, a user may close a page or may travel to a new page. When the ad opportunity disappears, the method of FIG. 7 may end or otherwise terminate. Advertisers with winning advertisements that were not displayed may be credited with the bid amount by the advertising system 140, given increased bidding rights in future auctions, and/or may still be charged for the bid amount. Various other examples are possible.

FIG. 7 depicts a method where a second or subsequent auction is run when a first set of advertisements have been completely displayed. However, in some systems, a new set of advertisement may be gathered, or the first set of advertisements may be modified, before all of the advertisements from a first set of advertisements may be displayed. For example, in some systems, a user may select an additional advertisement request module 270. In other systems, subsequent auctions may be conducted at various intervals or times, or continuously, as the first set of advertisements are being displayed. In some of these systems, where higher bids are received than those for advertisements displayed in the first set of advertisements, the advertisements associated with the higher bids may be collected either form a new set of advertisements or may be added to the first set of advertisements. In some systems, the advertisements associated with the higher bids may be inserted into an order of display based on the bid amount, or may be placed at the end of the order of the first set of advertisements. In some systems, additional advertisements may be gathered throughout the display of the first set of advertisements, such as where additional information about a user is discovered during the display of the first set of advertisements, which may make one or more other advertisements more or less relevant. In some systems, a second or new set of advertisements may be gathered and the original or previous set of advertisements may be discarded or removed from a rotation or display. Other variations are possible.

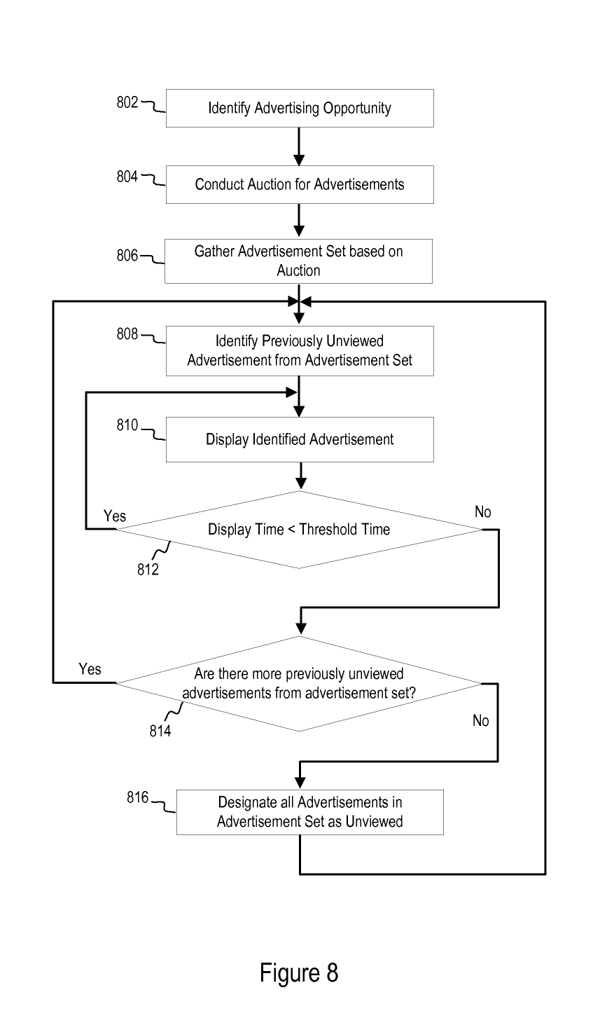

FIG. 8 illustrates another method of managing advertisement campaigns and advertisement displays. Blocks 802, 804, 806, 808, 810, and 812 in FIG. 8 may be similar or identical to blocks 702, 704, 706, 708, 710, and 712 of FIG. 7, respectively.

At block 814 of the method in FIG. 8, a determination may be made if there are more previously unviewed advertisements from the advertisement set. If there are, the method may proceed back to block 808, in a manner similar to how the method in FIG. 7 proceeds back to block 708.

If, however, there are no more previously unviewed advertisements from the advertisement set, the method may proceed to block 816 where all of the original winning advertisements from the advertisement set may be designated as unviewed advertisements, even though they had been viewed once before. From block 816, the method may then return back to block 708, one of the winning advertisements from the first advertisement set is again chosen to be displayed. In this way, the advertising system 140 may merely recycle the original winning advertisements once all have been displayed, without conducting any subsequent auctions.

In another variation, where at block 814 there are no more previously unviewed advertisements from the advertisement set, the method may instead leave the last advertisement displayed in the ad opportunity until the ad opportunity ends. As an alternative, the system may delete the advertising space or ad opportunity from the web page or content if there are no more previously unviewed advertisements. Other examples and methods are possible.

At any point throughout the methods of FIGS. 7 and 8, the ad opportunity may end or disappear. For example, a user may close a page or may travel to a new page. When the ad opportunity disappears, the methods of FIGS. 7 and 8 may end or otherwise terminate. Advertisers with winning advertisements that were not displayed may be credited with the bid amount by the advertising system 140, given increased bidding rights in future auctions, and/or may still be charged for the bid amount. Various other examples are possible.

In some systems and methods, at any point throughout the methods of FIG. 7 or 8, a user may select, click, activate, or otherwise interact with one of the displayed advertisements. Where the displayed advertisement is an interactive advertisement, various functions may occur upon interaction. For example, additional information or advertisements related to the interacted advertisement may be displayed, or the user may be redirected from the requested content or page to a web page related to the advertisement. In some other systems where the displayed advertisement is not an interactive advertisement, data about the interaction with the advertisement may be recorded and/or used in subsequent auctions as additional information about the user. Other variations are possible.

The methods of FIGS. 7 and 8 may allow for an auction to be held to determine, select, and/or gather multiple advertisements to be displayed in one ad opportunity at one time. The method of FIG. 7 may also allow for subsequent auctions to be performed where the ad opportunity still exists after each of the original winning advertisements have already been displayed.

While the systems and methods of FIGS. 2-8 describe rotating an advertisement after a given time period or when a rotation control input, such as a “forward” or “back” button, is activated, various other events may trigger the rotation of an advertisement in the interactive advertisement display 220. In some systems and methods, an advertisement may be rotated when a user clicks on or switches between a tab, button, link, application, and/or icon on the page 200, such as within the content 210. As an example, a rotation of an advertisement may be triggered when a user selects a message on an email portal to read. As another example, a rotation of an advertisement may be triggered when a user moves between tabs on a page or switches between applications. Other examples are possible. In some systems and methods, an advertisement may be rotated when a user scrolls up or down a page or fold. For example, if an advertisement 410 is displayed in the interactive advertisement display 220, when a user scrolls down a page 200, the next advertisement 420 may be rotated into the display area 230 of the interactive advertisement display 220 in place of the advertisement 410. In some systems, an advertisement rotation may occur in any one of at least six possible scenarios, including after a time has expired, when a rotation input control is selected, when an advertisement identifier is selected, when a user selected or otherwise activates an icon within the page 200, when a user selects or otherwise activates an additional advertisement request module 270, and/or when a user scrolls up or down on a page 200. These options may provide a user with significant control over the advertisements that the user may view. Other examples are variations are possible.

While the above described methods and systems may refer to a comparison and/or determination as to whether one element is greater than or equal to a second element, in some embodiments one or more of these comparisons may be replaced by a comparison and/or determination as to whether one element is greater than a second element. Similarly, comparisons and/or determinations described as being “greater than” may also be replaced with “greater than or equal to.” While the above described methods may refer to a comparison and/or determination as to whether one element is less than or equal to a second element, in some embodiments one or more of these comparisons may be replaced by a comparison and/or determination as to whether one element is less than a second element. Similarly, comparisons and/or determinations described as being “less than” may also be replaced with “less than or equal to.” Comparisons and/or determinations made which require an element to “exceed” a second element may be replaced by comparisons and/or determinations which require an element to “exceed or equal” a second element, and vice versa.

The methods and systems described herein may be used, for example, by or with one or more online providers in communication with the advertising system 140 or data store 145. The methods and systems described herein may not be limited to use with advertisements or with only online media. The methods and systems may be also or alternatively be used with any system or model involving displaying information or graphics, gathering one or more sets of data, or performing multiple successive auctions. For example, this type of display may be used with radio, print, billboard, and/or television mediums or other mediums. The displays may not be limited to advertisements, but also may be used to display other content, such as live data like stock quotes, game scores or statistics, and news, and/or other content such as flight times, movie showtimes, information about an event, and/or other information.

The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement system 140. The standalone application 125B may be programmed in any programming language that supports communication protocols. These languages may include: ORACLE JAVA®, C++, C#, ASP, JAVASCRIPT, asynchronous JAVASCRIPT, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE® or other smart phone. Any of the web applications, standalone applications and mobile applications 115, 125A-125N may individually be referred to as a user application or a client application.

The client applications 115, 125A-125N and/or the advertising system 140 may be one or more computing devices of various kinds, such as the computing device shown in FIG. 9. FIG. 9 illustrates an embodiment of a general computer system designated 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 904 includes a cache or random access memory for the processor 902. In alternative embodiments, the memory 904 is separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts or tasks illustrated in the figures or described herein may be performed by the programmed processor 902 executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 910, such as a liquid crystal display (LCD), an organic light emitting diode (OLED), a flat panel display, a solid state display, a cathode ray tube (CRT), a projector, a printer or other now known or later developed display device for outputting determined information. The display 910 may act as an interface for the user to see the functioning of the processor 902, or specifically as an interface with the software stored in the memory 904 or in the drive unit 916.

Additionally or alternatively, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the computer system 900.

The computer system 900 may also or alternatively include a disk or optical drive unit 916. The disk drive unit 916 may include a computer-readable medium 922 in which one or more sets of instructions 924, e.g. software, can be embedded. Further, the instructions 924 may embody one or more of the methods or logic as described herein. The instructions 924 may reside completely or partially within the memory 904 and/or within the processor 902 during execution by the computer system 900. The memory 904 and the processor 902 also may include computer-readable media as discussed above.

In some systems, a computer-readable medium 922 includes instructions 924 or receives and executes instructions 924 responsive to a propagated signal so that a device connected to a network 926 can communicate voice, video, audio, images or any other data over the network 926. Further, the instructions 924 may be transmitted or received over the network 926 via a communication port or interface 920, and/or using a bus 908. The communication port or interface 920 may be a part of the processor 902 or may be a separate component. The communication port 920 may be created in software or may be a physical connection in hardware. The communication port 920 may be configured to connect with a network 926, external media, the display 910, or any other components in system 900, or combinations thereof. The connection with the network 926 may be a physical connection, such as a wired Ethernet connection or may be established wirelessly as discussed below. Likewise, the additional connections with other components of the system 900 may be physical connections or may be established wirelessly. The network 926 may alternatively be directly connected to the bus 908.

While the computer-readable medium 922 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The computer-readable medium 922 may be non-transitory, and may be tangible.

The computer-readable medium 922 can include a solid-state memory such as a memory card or other package that houses one or more non-volatile read-only memories. The computer-readable medium 922 can be a random access memory or other volatile re-writable memory. Additionally or alternatively, the computer-readable medium 922 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 900 may be connected to one or more networks 926. The network 926 may be the same as, similar to, and/or in communication with networks 130 and/or 135. Any of networks 130, 135, and 926 may be wired or wireless. The wireless network may be a cellular telephone network, an 802.11, 802.16, 802.20, or WiMax network. Further, the networks 130, 135, and 926 may be a public network, such as the Internet, a private network, such as an intranet, or combinations thereof, and may utilize a variety of networking protocols now available or later developed including, but not limited to TCP/IP based networking protocols. The networks 130, 135, and 926 may include wide area networks (WAN), such as the Internet, local area networks (LAN), campus area networks, metropolitan area networks, a direct connection such as through a Universal Serial Bus (USB) port, or any other networks that may allow for data communication. The networks 130, 135, and 926 may be configured to couple one computing device to another computing device to enable communication of data between the devices. The networks 130, 135, and 926 may generally be enabled to employ any form of machine-readable media for communicating information from one device to another. The networks 130, 135, and 926 may include communication methods by which information may travel between computing devices. The network 130 may include the Internet and may include all or part of network 135; network 135 may include all or part of network 130. The networks 130, 135, and 926 may be divided into sub-networks. The sub-networks may allow access to all of the other components connected to the networks 130, 135 in the system 100, or the sub-networks may restrict access between the components connected to the networks 130, 135. The networks 130, 135, and 926 may be regarded as a public or private network connection and may include, for example, a virtual private network or an encryption or other security mechanism employed over the public Internet, or the like.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer-implemented interactive advertisement display on a page, the interactive advertisement display comprising:
a display area for displaying an advertisement from a set of advertisements; and
a rotation control input module configured to receive a rotation control input controlling which advertisement from the set of advertisements is displayed in the display area.

2. The interactive advertisement display of claim 1, further comprising an advertisement indicator identifying the advertisement from the set of advertisements displayed in the display area.

3. The interactive advertisement display of claim 1, further comprising a plurality of selectable advertisement indicators, where each of the advertisements from the set of advertisements corresponds to one of the selectable advertisement indicators.

4. The interactive advertisement display of claim 3, where each selectable advertisement indicator is configured to control the display area to display the advertisement corresponding to the selectable advertisement indicator when the selectable advertisement indicator is selected.

5. The interactive advertisement display of claim 1, where the rotation control input module comprises a pause button that controls the display area to pause the advertisement displayed in the display area.

6. The interactive advertisement display of claim 1, where the display area is configured to display each of the advertisements from the set of advertisements individually for a period of time and in an order when no rotation control input is received.

7. The interactive advertisement display of claim 6, where the rotation control input changes the order that each of the advertisements from the set of advertisements will be displayed in the display area.

8. The interactive advertisement display of claim 1, where the display area is configured to replace the displayed advertisement with another advertisement from the set of advertisements when a user scrolls up or down the page.

9. The interactive advertisement display of claim 1, where the display area is configured to replace the displayed advertisement with another advertisement from the set of advertisements when a user interacts with a tab or icon on the page.

10. The interactive advertisement display of claim 1, further comprising an additional advertisement request module configured to receive a request for a new set of advertisements to be displayed in the display area.

11. A computer-implemented method of displaying advertisements, comprising:
displaying a set of advertisements with an interactive advertisement display on a page according to a default display parameter, where the interactive advertisement display comprises a display area, and where only one advertisement of the set of advertisements is fully displayed within the display area at any time;
monitoring a rotation control input module to detect rotation control inputs;
creating a modified display parameter when a rotation control input is detected, the modified display parameter based on the detected rotation control input; and
displaying the set of advertisements within the display area on the page according to the modified display parameter when the rotation control input is detected.

12. The method of claim 11, further comprising:
monitoring a close advertisement module to detect close advertisement inputs; and
minimizing or removing the interactive advertisement display when a close advertisement input is received.

13. The method of claim 11, further comprising:
monitoring advertisement identifiers each corresponding to one advertisement in the set of advertisements to detect advertisement identifier selections; and
displaying an advertisement from the set of advertisements associated with an advertisement identifier within the display area when the advertisement identifier is selected.

14. The method of claim 11, further comprising:
monitoring an additional advertisement request module to detect additional advertisement requests;
gathering new advertisements when an additional advertisement request is detected; and
displaying the new advertisements within the display area on the page in place of the set of advertisements.

15. The method of claim 11, further comprising transitioning from one displayed advertisement to the next displayed advertisement using a plurality of virtual three-dimensional objects.

16. An advertising system comprising a non-transitory computer readable storage medium having stored therein data representing instructions executable by a programmed processor for displaying advertisements, the storage medium comprising:
instructions for generating a display area for displaying a set of advertisements, the display area divided into a plurality of segments;
instructions for displaying a first advertisement in the display area, where each of the plurality of segments displays a portion of the first advertisement; and
instructions for transitioning from displaying the first advertisement in the display area to displaying a second advertisement in the display area, the transitioning including changing the display in each of the plurality of segments of the display area at different times.

17. The advertising system of claim 16, where each of the plurality of segments as displayed as a virtual three-dimensional object.

18. The advertising system of claim 17, where each virtual three-dimensional object includes a first face configured to display a portion of the first advertisement and a second face configured to display a portion of the second advertisement;
where the first face of each virtual three-dimensional object is displayed and the second face of each three-dimensional object is not displayed when the first advertisement is displayed; and
where changing the display in each of the plurality of segments of the display area includes rotating each of the plurality of segments of the display area to display the second face of the virtual three-dimensional object.

19. The advertising system of claim 17, where the three-dimensional object of each of the plurality of segments has two side panels and n faces, each of the n faces configured to display a portion of one of n advertisements, respectively; and
where changing the display in each of the plurality of segments of the display area includes rotating each three-dimensional object (360/n) degrees along an axis through the center of the three-dimensional object.

20. The advertising system of claim 16, where the display area is configured to display multiple advertisements at one time.
